(19) United States
(12) Patent Application Publication
(10) Pub. No.: US 2007/0144490 A1
(43) Pub. Date: Jun. 28, 2007

(54) CONTROL METHOD OF A COMMON-RAIL TYPE SYSTEM FOR DIRECT FUEL INJECTION INTO AN INTERNAL COMBUSTION ENGINE

(75) Inventors: Gabriele Serra, San Lazzaro Di Savena (IT); Matteo De Cesare, Torremaggiore (IT)

Correspondence Address: ROGER PITT;KIRKPATRICK & LOCKHART PRESTON GATES ELLIS LLP, 599 LEXINGTON AVENUE, 33RD FLOOR, NEW YORK, NY, 10022-6030, US

(73) Assignee: MAGNETI MARELLI POWERTRAIN S.p.A., CORBETTA (IT)

(21) Appl. No.: 11/614,247

(22) Filed: Dec. 21, 2006

(30) Foreign Application Priority Data
Dec. 28, 2005 (EP) 05425931.2

(51) Int. Cl. F02M 59/36

(52) U.S. Cl. 123/458

(57) ABSTRACT

A control method for a direct fuel injection system into an internal combustion engine provided with a number of cylinders; the method presents the stages of: supplying pressurised fuel to a common rail by means of a high-pressure pump; cyclically driving a number of hydraulically actuated injectors having an hydraulically actuated needle to inject fuel into the cylinders; establishing a desired fuel pressure level within the common rail; determining a threshold value for the injectors so that no fuel is injected by each injector if it is driven for a time interval shorter than the threshold value; and reducing the actual fuel pressure within the common rail by driving the injectors for a driving time interval shorter than the threshold value.

The present invention relates to a control method of a common-rail type system for direct fuel injection into an internal combustion engine.

### BACKGROUND OF THE INVENTION

In current direct fuel injection systems of the common-rail type, a low-pressure pump supplies fuel from a tank to a high-pressure pump, which in turn supplies the fuel to a common rail. A series of injectors (one for each cylinder of the engine) is connected to the common rail, such injectors being cyclically driven in order to inject part of the pressurised fuel present in the common rail into a respective cylinder. If combustion is to operate correctly, it is important for the fuel pressure level within the common rail to be constantly maintained at a desired level that generally varies according to the engine point.

In order to maintain the pressure level of the fuel within the common rail equal to the desired level, it was proposed to dimension the high-pressure pump so as to supply the common rail at any operating state with a quantity of fuel that exceeds actual consumption; a pressure regulator is coupled to the common rail, which regulator maintains the fuel pressure level within the common rail at the desired level by discharging excess fuel to a recirculation channel which reintroduces the excess fuel itself upstream of the low-pressure pump. An injection system of this type has various drawbacks, as the high-pressure pump must be dimensioned so as to supply the common rail with a quantity of fuel that slightly exceeds the maximum possible consumption; however, such maximum possible consumption state occurs relatively rarely and in all other operating states the quantity of fuel supplied to the common rail by the high-pressure pump is much greater than that actually consumed and thus a considerable proportion of fuel must be discharged by the pressure regulator into the recirculation channel. The work performed by the high-pressure pump in pumping fuel that is subsequently discharged by the pressure regulator is “pointless” work, and therefore this injection system has a very low energy efficiency. Moreover, this injection system has a tendency to overheat the fuel, as when the excess fuel is discharged by the pressure regulator into the recirculation channel, the fuel itself passes from a very high pressure (also higher than 1000 bars) to a substantially ambient pressure and such pressure drop tends to increase the temperature of the fuel.

In order to overcome the problems described above, a solution proposes the use of a variable displacement high-pressure pump capable of supplying to the common rail only the quantity of fuel needed to maintain the fuel pressure within the common rail equal to the required level.

For example, Patent Application EP0481964A1 describes a high-pressure pump provided with an electromagnetic actuator capable of varying the flow rate of the high-pressure pump instant-by-instant by varying the closure instant of an intake valve of the high-pressure pump itself. In other words, the high-pressure pump flow rate is varied by varying the closure instant of the intake valve of the high-pressure pump itself; in particular, the flow rate is decreased by delaying the closure instant of the intake valve and is increased by advancing the closure instant of the intake valve.

A further example of a variable displacement high-pressure pump is provided by U.S. Pat. No. 6,116,870A1. The high-pressure pump described in U.S. Pat. No. 6,116,870A1 comprises a cylinder provided with a piston that has reciprocating motion within a cylinder, an intake channel, a delivery channel coupled to the common rail, an intake valve capable of permitting an input flow of fuel into the cylinder, a one-way delivery valve coupled to the delivery channel and capable of permitting only fuel flow the cylinder, and a regulating device coupled to the intake valve to maintain the intake valve open during a compression stroke of the piston and therefore of permitting a fuel flow the cylinder through the intake channel. The intake valve comprises a mobile valve body along the intake channel and a valve seat, which is capable of being engaged in a fluid-tight manner by the valve body and is arranged at the end of the intake channel opposite the end communicating with the cylinder. The regulating device comprises a control element, which is coupled to the valve body and is mobile between a passive position, in which it permits the valve body to act in a fluid-tight manner upon the valve seat, and an active position, in which it does not permit the valve body to act in a fluid-tight manner upon the valve seat; the control element is coupled to an electromagnetic actuator, which is capable of displacing the control element between the passive position and the active position.

In combination with the variable displacement high-pressure pump, a pressure regulator controlled by a control unit may be present to release excess fuel from the common rail into a recirculation channel. In this case, during an increasing pressure transient, the pressure within the common rail is controlled by the high-pressure pump itself, while during a decreasing transient, the pressure within the common rail is controlled by the pressure regulator. This constructive solution which envisages the presence of both the variable displacement high-pressure pump and of the pressure regulator permits to rapidly and precisely follow the desired fuel pressure level within the common rail; however, this constructive solution which envisages the presence of both the variable displacement high-pressure pump and the pressure regulator has on the other hand high manufacturing costs.

In order to reduce manufacturing costs, elimination of the pressure regulator was proposed; in this case, during an increasing pressure transient, the pressure within the common rail is controlled by the high-pressure pump itself, while during a decreasing pressure transient, the pressure within the common rail is somehow limited by the fuel flow rate used by the injectors for operation and by the fuel flow rate lost through leaks. It is important to observe that this solution can only be used in the presence of injectors with hydraulically actuated needle and not with electromagnetically actuated needle injectors, as only the hydraulically operated needle injectors discharge part of the pressurised fuel received from the common rail into a discharge conduit towards the tank. This constructive solution without pressure regulator presents lower manufacturing costs, but on the other hand does not permit to very accurately follow the desired fuel pressure level within the common rail; such limitation occurs particularly during the injector cut-off stage in which the injectors are not driven and therefore no fuel is injected into the cylinders. During an injection cut-off stage, the fuel pressure level within the common rail must be rapidly reduced to achieve optimal conditions for combustion (in particular low noise) when fuel injection is resumed, i.e. when the engine starts outputting torque again; however, during an injection cut-off stage the injectors are not driven and therefore the only fuel pressure reduction within the common rail is generated by the fuel flow rate lost through leaks and such reduction is widely insufficient with respect to the desired reduction.

### SUMMARY OF THE INVENTION

It is the object of the present invention to provide a control method for a common rail type system for direct fuel injection into an internal combustion engine, which is free from the aforementioned drawbacks and, in particular, is easy and cost-effective to make.

According to the present invention, a control method of a common-rail type system for the direct injection of fuel into an internal combustion engine is provided as claimed in the attached claims.

### BRIEF DESCRIPTION OF THE DRAWINGS

The present invention will now be described with reference to the accompanying drawings illustrating a non-limitative embodiment example, in which:

FIG. 1 is a schematic view of a common-rail type direct fuel injection system made in accordance with the present invention;

FIG. 2 is a schematic view, in side elevation and sectioned, of a fuel injector of the direct fuel injection system in FIG. 1; and

FIG. 3 is a magnified view of a detail in FIG. 2.

### DETAILED DESCRIPTION OF THE INVENTION

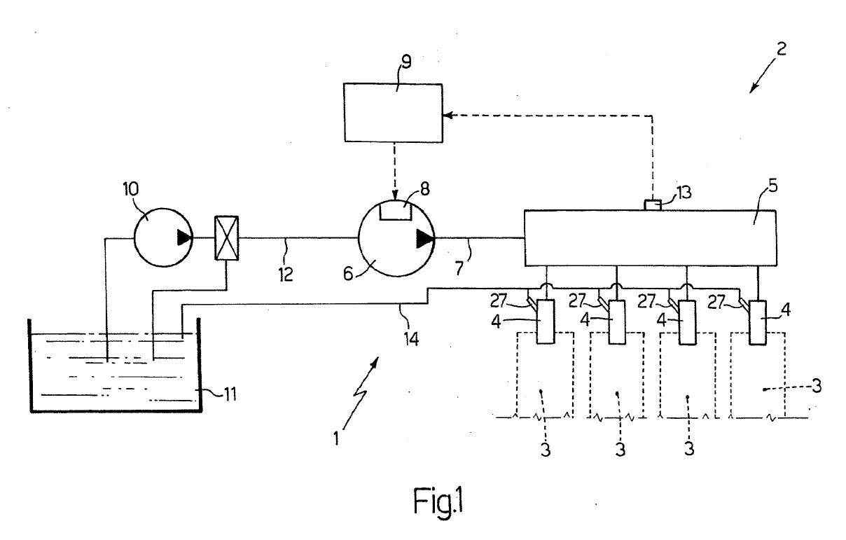

In FIG. 1, number 1 indicates as a whole a common-rail type system for direct fuel injection into an internal combustion engine 2 provided with four cylinders 3. The injection system 1 comprises four injectors 4, each of which capable of injecting fuel directly into a respective cylinder 3 of the engine 2 and receiving the pressurised fuel from a common rail 5.

A high-pressure pump 6 supplies the fuel to the common rail 5 through a tube 7 and is provided with a flow rate regulating device 8 driven by a control unit 9 capable of maintaining the fuel pressure within the rail 5 equal to the desired level generally variable in time according to the engine point (i.e. the engine running states). For example, the regulating device 8 comprises an electromagnetic actuator (not shown) capable of varying the fuel flow rate m_{HP} from the high-pressure pump 6 instant-by-instant by varying the closure instant of an intake valve (not shown) of the high-pressure pump 6 itself. In other words, the fuel flow rate m_{HP} from the high-pressure pump 6 is varied by varying the closure instant of the intake valve (not shown) of the high-pressure pump 6 itself; in particular, the fuel flow rate m_{HP} is decreased by delaying the closure instant of the intake valve (not shown) and is increased by advancing the closure instant of the intake valve (not shown).

An essentially constant flow rate low-pressure pump 10 supplies the fuel from a tank 11 to the high-pressure pump 6 by means of a tube 12.

The control unit 9 controls the fuel flow rate m_{HP} from the high-pressure pump 6 by means of a feedback control using a feedback variable the fuel pressure level within the common rail 5, level of the pressure detected in real time by a sensor 13.

Each injector 4 is cyclically driven by a control unit 9 for injecting fuel into a respective engine cylinder 3. The injectors 4 have a hydraulic needle actuator and are thus connected to a discharge channel 14, which has an ambient pressure and leads upstream of the low-pressure pump 10, typically into the tank 11.

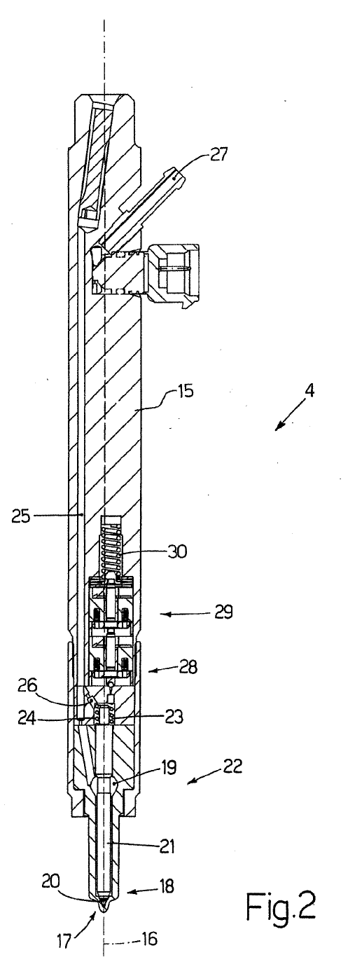

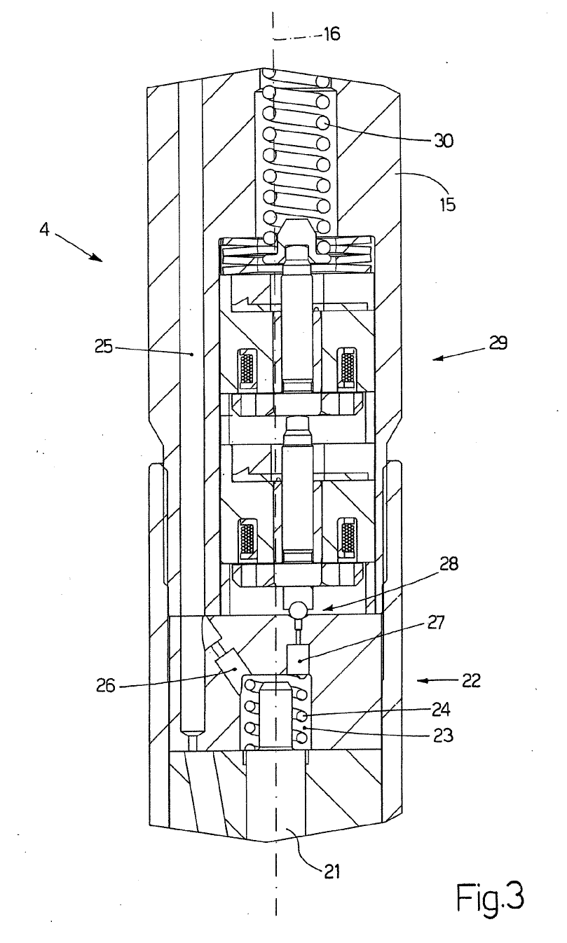

According to that shown in FIGS. 2 and 3, each fuel injector 4 is accommodated within a cylindrical body 15 having a longitudinal axis 16 and is controlled to inject fuel from an injection nozzle 17 regulated by an injection valve 18. An injection chamber 19 is obtained within the cylindrical body 15, which is inferiorly delimited by a valve seat 20 of the injection valve 18 and slidingly accommodates a bottom portion of a needle 21 of the injection valve 18, so that the needle 21 can be displaced along the longitudinal axis 16 under the bias of a hydraulic actuating device 22 between a closed position and an open position of the valve seat 20.

An upper portion of the needle 21 is accommodated in a control chamber 23 and is coupled to a spring 24 which exerts on the needle 21 itself a downward force which tends to hold the needle 21 itself in closed position.

The cylindrical body 15 further presents a supply channel 25, which starts on one upper end of the cylindrical body 15 and supplies the pressurised fuel to the injection chamber 19; a further supply channel 26 branches off from the supply channel 25, the supply channel 26 being capable of putting into communication the supply channel 25 and the control chamber 23 to supply the pressurised fuel also into the control chamber 23.

From the control chamber 23 departs a discharge conduit 27, which leads into an upper portion of the cylindrical body 15 and puts the control chamber 23 into communication with the discharge channel 14; the discharge conduit 27 is regulated by a drive valve 28, which is arranged near the control chamber 23 and controlled by an electromagnetic actuator 29 between a closed position, in which the control chamber 23 is isolated from the discharge conduit 27, and an open position, in which the control chamber 23 is connected to the discharge conduit 27. The electromagnetic actuator 29 comprises a spring 30 which tends to maintain the drive valve 28 in closed position.

The supply channel section 26, the drive valve section 28 and the discharge conduit section 27 are dimensioned with respect to the supply channel section 25 so that, when the drive valve 28 is open, the pressure in the control chamber 23 drops to levels much lower than the fuel pressure in the injection chamber 19 and so that the fuel flowing through the discharge conduit 27 is a fraction of the fuel flow rate flowing through the injection nozzle 17.

In use, the electromagnetic actuator 29 is de-energised, the force generated by the spring 30 holds the drive valve 28 in closed position; therefore, the fuel pressure in the control chamber 23 is the same as the fuel pressure in the injection chamber 19 by effect of the supply channel 26. In this situation, the force generated by the spring 25 and the hydraulic force generated by the imbalance of the active areas of the needle 21 to the advantage of the control chamber 23 with respect to the injection chamber 19 hold the injection valve 18 in closed position.

When the electromagnetic actuator 29 is energised, the drive valve 28 is taken to open position against the bias of the spring 30, therefore the control chamber 23 is put into communication with the discharge channel 14 and the fuel pressure in the control chamber 23 drops to levels very much lower than the fuel pressure in the injection chamber 19; as mentioned above, the difference between the fuel pressure within the injection chamber 19 and within the control chamber 23 is due to the dimensioning of the sections of the supply channel 26, of the drive valve 28 and of the discharge conduit 27 with respect to the supply channel section 25.

By effect of the imbalance between fuel pressures in the injection chamber 19 and in the control chamber 23, a hydraulic force which displaces the needle 21 upwards is generated on the needle 21 against the bias of the spring 24 so as to take the injection valve 18 to the open position and to permit fuel injection through injection nozzle 17.

When the electromagnetic actuator 29 is de-energised, the force generated by the spring 30 returns the drive valve 28 to the closed position; therefore, the fuel pressure in the control chamber 23 tends to increase and reach the fuel pressure in the injection chamber 19. In this situation, the force generated by the spring 24 and the hydraulic force generated by the imbalance of the active areas of the needle 21 to the advantage of the control chamber 23 with respect to the injection chamber 19 return the injection valve 18 to the mentioned closed position.

Preferably, the supply channel 26 presents a bottleneck to obtain an instantaneous increase of pressure difference between the control chamber 23 and the injection chamber 19 during the closing transient of the needle 21 (i.e. when the needle 21 goes from the open position to the closed position) so as to increase the force acting on the needle 21 and, therefore, to speed up closure of the needle 21 itself.

From the above, it is apparent that when the electromagnetic actuator 29 of an injector 4 is controlled, the drive valve 28 is initially opened and the fuel present in the control chamber 23 starts flowing through the discharge conduit 27 and to the discharge channel 14; after a certain interval of time from the drive valve 28 opening, a hydraulic bias force is generated on the needle 21 causing the injection valve 18 to open and therefore the supply of fuel through the injection nozzle 17.

In other words, the fuel supply through the injection nozzle 17 occurs only if the electromagnetic actuator 29 of an injector 4 is controlled for a time range higher than a certain ETmin threshold value; instead, if the electromagnetic actuator 29 of an injector 4 is controlled for an interval of time shorter than the threshold value ETmin, then the drive valve 28 may open and consequently fuel is output to the discharge channel 14, but fuel is not supplied through the injection nozzle 17. Obviously, if the electromagnetic actuator 29 of an injector 4 is controlled for a brief interval of time very much shorter than the threshold value Etmin, then the drive valve 28 is not even opened.

The threshold value ETmin of an injector 4 is linked to the features, the tolerances and the aging of the components of the injector 4 itself; consequently, the threshold value ETmin may vary (slightly) from injector 4 to injector 4 and for the same injector 4 may vary (slightly) also during the life of the injector 4 itself. Furthermore, the threshold value ETmin of an injector 4 may, in reversely proportional manner, vary with the pressure level of the fuel in the common rail 5, i.e. the higher is the fuel pressure in the common rail 5, the lower will be the threshold value ETmin.

With reference to FIG. 1, the control unit 9 determines a desired fuel pressure level within the common rail 5 instant-by-instant according to the engine point and consequently acts so that the actual fuel pressure level within the common rail 5 follows the desired level rapidly and accurately.

The fuel pressure variation dP/dt within the common rail 5 results from the following state equation of the common rail 5:
dP/dt=(k_{b}/Vr)×(m_{HP}−m_{Inj}−m_{Leak}−m_{BackFlow})
in which:
dP/dt is the fuel pressure variation within the common rail 5;
k_{b} is the fuel bulk module;
Vr is the volume of the common rail 5;
m_{HP} is the fuel flow rate of the high-pressure pump 6;

m_{Inj} is the fuel flow rate injected in cylinders 3 of the injectors 4;

m_{Leak} is the fuel flow rate lost through leaks from the injectors 4;

m_{BackFlow} is the fuel flow rate absorbed by the injectors 4 for actuation and discharged into the discharge channel 14.

From the equation above it is apparent that during the compression or pumping stroke of the high-pressure pump 6 the fuel pressure variation dP/dt within the common rail 5 may be positive; in particular, the fuel pressure variation dP/dt within the common rail 5 is positive if the fuel flow rate m_{HP} of the high-pressure pump 6 is higher than the sum of the other contributions. Instead, during the intake stroke of the high-pressure pump 6, the fuel flow rate m_{HP} from the high-pressure pump 6 is null and therefore the fuel pressure variation dP/dt within the common rail 5 is always negative not being possible to fully cancel the fuel flow rate lost through leaks by the injectors 4.

During the compression or pumping stroke of the high-pressure pump (increasing pressure transient) the fuel flow rate m_{HP} from the high-pressure pump 6 is positive and the control unit 9 controls the high-pressure pump 6 to control the pressure within the common rail 5. In other words, during the compression or pumping stroke of the high-pressure pump 6 the fuel pressure variation dP/dt within the common rail 5 depends directly on the fuel flow rate m_{HP} from the high-pressure pump 6, being such fuel flow rate m_{HP} not null; consequently, the control unit 9 may easily regulate the fuel pressure within the common rail 5 by regulating the fuel flow rate m_{HP} from the high-pressure pump 6 by means of the regulating device 8.

During the intake stroke of the high-pressure pump 6 (decreasing pressure transient) the fuel flow rate m_{HP} from the high-pressure pump 6 is null and therefore, as previously mentioned, the fuel pressure variation dP/dt within the common rail 5 is always negative as it is not possible to fully cancel the fuel flow rate lost through leaks from the injectors 4. During the intake stroke of the high-pressure pump 6, the control unit 9 does not intervene in any way if the actual fuel pressure level within the common rail 5 is lower than the desired level.

Instead, if during the intake stroke of the high-pressure pump 6, the fuel pressure within the common rail 5 is higher than the desired level, then the control unit 9 may decide to decrease fuel pressure within the common rail 5 more rapidly by driving the injectors 4 (i.e. by energising the electromagnetic actuators 29 of the injectors 4) for a driving time interval ETred close to, but shorter than the respective threshold values ETmin when the injectors 4 themselves are not used for injecting the fuel required for the combustion process. In this way, no fuel is injected into the cylinders 3, but the fuel flow rate absorbed by the injectors 4 is increased for their actuation and discharged into the discharge channel 14. It is important to stress than the driving time interval ETred during which each injector 4 is driven must be shorter than the threshold value ETmin, but must not be excessively shorter than the threshold value ETmin otherwise the quantity of fuel discharged into the discharge channel 14 will be either not very significant or even null.

Such control strategy envisaging a series of micro-actuations of the injectors 4 to rapidly reduce the fuel pressure inside the common rail 5 is generally used during the injection cut-off stage, during which the injectors 4 are not driven and therefore no fuel is injected into the cylinders 3. Indeed, during an injection cut-off stage, the fuel pressure within the common rail 5 must be rapidly reduced to obtain the optimal conditions for combustion (in particular low noise) when fuel injection is resumed, i.e. when the engine 2 resumes torque output.

During an injection cut-off stage, the driving time interval ETred of each injector 4 generally depends on the fuel pressure within the common rail 5 and must be shorter than the threshold value ETmin to avoid injecting undesired fuel into the cylinders 3. As previously mentioned, being the threshold value ETmin variable from injector 4 to injector 4, in addition to being variable during the life of an injector 4 itself, an algorithm for optimising the driving time interval ETred of each injector 4 is preferably implemented in the control unit 9 to prevent such driving time interval ETred from exceeding the threshold value ETmin.

According to a possible embodiment, during an injection cut-off stage, the driving of each injector 4 may be timed with each cylinder 3 at compression stroke; in other words, each injector 4 is driven in a synchronised manner, not randomly, with a certain angular position of the respective cylinder 3. Such embodiment presents the limit of allowing to drive only one injector 4 at a time and has the advantage of making easily detectable the exceeding the threshold value ETmin by detecting possible accelerations of a crankshaft (not shown) of the engine 2 or possible sudden pressure increases within the cylinder 3. In other words, by driving an injector 4 with its respective cylinder 3 in a synchronised manner, it results that a possible undesired injection of fuel would determine a fuel combustion with a consequent generation of overpressure within the cylinder 3 and a consequent generation of motive torque causing acceleration of the crankshaft (not shown). Alternatively, an unexpected combustion within a cylinder 3 may be determined also by observing the A/F (Air/Fuel) ratio in exhaust by reading a respective sensor (not shown).

According to an alternative embodiment, during the injection cut-off stage, each injector 4 may be driven using a non-timed command sequence; in other words, each injector 4 is driven in random manner with respect to the angular position of the respective cylinder 3. By driving an injector 4 in non-synchronised manner with its respective cylinder 3, it results that a possible undesired fuel injection would not (or only seldom) cause fuel combustion. Such embodiment has the advantage of allowing to drive several injectors 4 at the same time, making pressure discharge more rapid without a perceivable torque output if the threshold values ETmin are exceeded; on the other hand, such embodiment has the disadvantage of making the detection of possible exceeding of threshold values ETmin more complicated as such detection may only be performed by observing the quantity of exhaust gas by means of a linear oxygen probe or UEGO probe (not shown).

When the control unit 9 detects exceeding of the threshold values ETmin, the control unit 9 starts reducing the driving time interval ETred of each injector 4 to eliminate undesired fuel injections. Furthermore, when the control unit 9 does not detect any exceeding of threshold values ETmin, the control unit 9 may slightly increase the driving time interval ETred of each injector 4 to attempt to take the driving time interval ETred of each injector 4 as close as possible to the threshold value ETmin.

The aforementioned control strategy envisaging a series of micro-actuations of the injectors 4 to rapidly reduce the fuel pressure inside the common rail 5 presents the advantage of being particularly efficient and extremely cost-effective to implement as it only uses components normally present in a modern direct fuel injection engine.

1) A control method for a direct fuel injection system (1) into an internal combustion engine (2) provided with a number of cylinders (3); the method comprises the stages of:
supplying pressurised fuel to a common rail (5) by means of a high-pressure pump (6);
cyclically driving a number of injectors (4) having an hydraulically actuated needle (21) and connected to the common rail (5) to inject fuel directly into the cylinders (3);
establishing a desired fuel pressure level within the common rail (5); and
regulating the actual fuel pressure level within the common rail (5) according to the desired level by regulating the fuel flow rate (m_{HP}) from the high-pressure pump (6) during the compression or pumping stage of the high-pressure pump (6) itself;
the method is characterised in that it comprises the further stages of:
determining a threshold value (ETmin) for the injectors (4) so that no fuel is injected by each injector (4) if it is driven for a time interval shorter than the threshold value (ETmin); and
reducing the actual fuel pressure within the common rail (5) according to the desired level by driving the injectors (4) for a driving time interval (ETred) shorter than the threshold value (ETmin) when the injectors (4) themselves are not used to inject the fuel required by the combustion process.

2) A method according to claim 1, wherein the driving time interval (ETred) is shorter than the threshold value (ETmin) and close to the threshold value (ETmin) itself.

3) A method according to claim 1, and comprising the further stage of optimising the driving time interval (ETred) so as to ensure that the driving time interval (ETred) is shorter than the threshold value (ETmin).

4) A method according to claim 1, wherein the actual fuel pressure level within the common rail (5) is reduced by driving the injectors (4) for the driving time interval (ETred) shorter than the threshold value (ETmin) during an injection cut-off stage.

5) A method according to claim 4, wherein the optimisation stage comprising the further stages of:
detecting the possible presence of undesired fuel injections within the cylinders (3) during the injection cut-off stage; and
decreasing the driving time interval (ETred) in the presence of undesired fuel injections within the cylinders (3) during injection cut-off stage.

6) A method according to claim 5, wherein the optimisation stage comprises the further stage of:
increasing the driving time interval (ETred) of the injectors (4) in the case of prolonged absence of undesired fuel injections within the cylinders (3) during injection cut-off stage.

7) A method according to claim 5, wherein the presence of undesired fuel injections within the cylinders (3) during the injection cut-off stage is determined by detecting possible accelerations of a crankshaft of the engine.

8) A method according to claim 5, wherein the presence of undesired fuel injections within the cylinders (3) during the injection cut-off stage is determined by detecting possible sudden increases of pressure within the cylinders (3) themselves.

9) A method according to claim 5, wherein the presence of undesired fuel injections within the cylinders (3) during the injection cut-off stage is determined by observing the Air/Fuel ratio in exhaust.

10) A method according to claim 5, wherein the presence of undesired fuel injections within the cylinders (3) during the injection cut-off stage is determined by observing the quantity of exhaust gas by means of a linear oxygen probe.

11) A method according to claim 1, wherein, in order to reduce the actual fuel pressure level within the common rail (5), a single injector (4) is driven at a time and the driving of each injector (4) is timed with respect to the respective cylinder (3).

12) A method according to claim 11, wherein the driving of each injector (4) is timed with the compression stroke of the respective cylinder (3).

13) A method according to claim 1, wherein, in order to reduce the actual fuel pressure level within the common rail (5), the injectors (4) are not driven in a timed manner with respect to the cylinders (3).

14) A method according to claim 13, wherein several injectors (4) are driven simultaneously.

15) A method according to claim 1, wherein no regulating action on the fuel pressure within the common rail (5) is taken if the actual fuel pressure level within the common rail (5) is lower than the desired level.

16) A method according to claim 1, wherein each injector (4) is connected to a discharge channel (14) having a substantially ambient pressure; if an injector (4) is controlled for a time interval shorter than the threshold value (ETmin), then an output of fuel to the discharge channel (14) may occur but no fuel is injected into the cylinder (3).

17) A method according to claim 1, wherein the fuel flow rate (m_{HP}) from the high-pressure pump is regulated by varying the closure instant of an intake valve of the high-pressure pump 6 itself.
